(19) United States
(12) Patent Application Publication
(10) Pub. No.: US 2007/0137975 A1
(43) Pub. Date: Jun. 21, 2007

(54) Centrifugal clutch for vibration compaction machine

(75) Inventors: Giichi Tanaka, Shiraoka-machi (JP); Yoshinori Harashima, Satte-shi (JP); Kenichi Nagasawa, Hasuda-shi (JP); Kenichi Muramoto, Shiraoka-machi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Mikasa Sangyo Co., Ltd., Tokyo (JP)

(21) Appl. No.: 11/604,042

(22) Filed: Nov. 22, 2006

(30) Foreign Application Priority Data
Dec. 16, 2005 (JP) 2005-362764

(51) Int. Cl. F16D 43/18

(52) U.S. Cl. 192/105 BA

(57) ABSTRACT

In a vibration compaction machine such as a rammer, a lining wear dust is prevented from accumulating inside a clutch drum due to oblique attachment of a centrifugal clutch, such that the input shaft side is high and the output shaft side is low because of a forward tilted posture of the machine body.

Discharge ports for a lining wear dust are opened with a spacing therebetween in a corner section of a disk-shaped wall surface and an annular circumferential surface of a clutch drum in a centrifugal clutch that is disposed obliquely so that the input shaft is high and an output shaft is low, the discharge ports being obtained by cutting out portions of the annular circumferential surface close to the corner section.

### BACKGROUND OF THE INVENTION

1. Field of the Invention

The present invention relates to a centrifugal clutch of a power engine for use in a vibration compaction machine, such as a rammer, for compacting a road surface by hitting the road surface with a compaction plate that moves up and down.

2. Description of the Related Art

When compaction of a road surface is performed with a conventional vibration compaction machine such as a rammer, as shown in FIG. 4, in order to ensure that the machine body A can move forward automatically in a state where an operator holds a handle H, a central line P of the machine body is inclined at a predetermined angle with respect to the road surface C, and the machine body A is attached to the compaction plate B so that the C machine body maintains a forward inclined posture. As a result, the attachment is such that the input-output shaft line E of a power engine D mounted on the machine body A is inclined so that the input shaft K is above and the output shaft L is below the horizontal line F.

However, it was found that in the vibration compaction machines of such type, a wear ratio of a lining in a centrifugal clutch of the power engine is much higher than that in centrifugal clutches used in other industrial machines.

The reason therefor was studied and the results obtained demonstrated the following. As described hereinabove, in a centrifugal clutch used in a rammer, the input-output shaft line E of the power engine D is disposed obliquely, so that the input shaft K is high and the output shaft L is low, rather than parallel to the c horizontal line F, and therefore, as shown in FIG. 5, a corner section Q between a disk-shaped wall surface M and an annular circumferential surface N in a clutch drum G is inclined in the direction such as to be lower than an open edge Na of the annular circumferential surface N, and the wear dust falling down from the surface of a lining R is accumulated in the corner section Q between the disk-shaped wall surface M and the annular circumferential surface N of the drum G.

In the lining R provided on the outer periphery of a shoe weight W in a centrifugal clutch, the wear dust is chipped down from the surface of the lining R due to wear caused by sliding immediately before the lining comes into reliable contact with the inner peripheral surface of the drum G or immediately before the lining is separated from the drum. When the axial line of the drum G is disposed horizontally, as in the usual usage mode of the clutch, because the wear dust that was chipped down from the lining R is discarded to the outside along the annular circumferential surface N and does not remain inside the drum G, the occurrence of serious damage can be prevented.

However, as shown in FIG. 5, when the corner section Q of the disk-shaped wall surface M and annular circumferential surface N in the clutch drum G is inclined in the direction such as to be below the open edge Na of the annular circumferential surface N because of the forward tilted posture of the machine body A, the open edge Na is positioned above the corner section Q and the wear dust S that separated from the lining R is accumulated inside the corner section Q, rather than being discharged from the open edge Na.

The wear dust S that accumulated inside the corner section Q is not discharged from the open section Na located thereabove, remains all the time inside the corner section Q, does not easily flow out, receives a centrifugal force created by the rotation of the drum G, and adheres to the inner peripheral surface of the drum, thereby forming a layer. As a result, the internal volume of the clutch is decreased, the flow of air therethrough is impeded, and temperature is raised.

Furthermore, if the amount of the wear dust accumulating inside the corner section Q increases, when the clutch drum G comes into contact with the circumferential surface of the lining R, part of the wear dust that moves freely over the contact surface will be squeezed between the drum G and lining R. As a result, even if a friction action caused by rotation appears between the drum G and the lining R, a transmission loss occurs in the clutch, that is, the rotation power cannot be effectively transmitted form the input shaft K and the wear ratio of the lining R is larger than that in centrifugal clutches used in other industrial machines.

In centrifugal clutches for industrial applications in which power transmission is frequently interrupted, the clutch temperature often rises. A technology is known for inhibiting such temperature increase, which involves providing a ventilation port for passing a flow of air inside a clutch drum or a housing surrounding the clutch from the outside, introducing the air into the clutch, and suppressing the increase in temperature.

In a centrifugal clutch described in Japanese Utility Model Registration No. 3101343, because the input-output shaft line of a power engine is parallel to a horizontal line, even if the wear dust that separated from the lining falls down inside the drum, the wear dust is discharged into the housing from the open edge of the drum along the inner side of the annular circumferential surface.

The problem associated with such centrifugal clutch is that a ventilation port for passing a flow of air that comprises a guide vane is provided in the disk-shaped wall surface of the drum, but because this ventilation port is provided in the disk-shaped wall surface of the drum and is not provided in the annular circumferential surface, even though the external air can be caused to flow into the drum, the wear dust of the lining that fell down inside the drum cannot be efficiently discharged to the outside of the drum through the ventilation port.

### SUMMARY OF THE INVENTION

It is an object of the present invention to resolve the above-described problem inherent to centrifugal clutches for vibration compaction machines such as rammers and to provide a centrifugal clutch for industrial machinery in which a wear dust of a lining is not accumulated inside the clutch drum in an output shaft when the centrifugal clutch is mounted obliquely so that the input shaft K is high and the output shaft L is low.

As a specific means for configuring the above-described centrifugal clutch, the present invention provides a centrifugal clutch in which a clutch drum is disposed obliquely so that an input shaft side is high and an output shaft side is low in a power transmission unit of a vibration compaction machine for compacting a road surface by an up-down movement of a compaction plate, wherein a plurality of discharge ports for a lining wear dust are provided with a spacing therebetween in a corner section formed by a disk-shaped wall surface of the clutch drum and an annular circumferential surface provided at the circumferential edge section of the wall surface, those discharge ports being formed by cutting out portions of the annular circumferential surface close to this corner section.

The discharge ports for the lining dust may be provided in a corner section formed by a disk-shaped wall surface of the clutch drum and an annular circumferential surface provided at the circumferential edge section of the wall surface by cutting so that they extend from portions of the annular circumferential surface to portions of the disk-shaped wall surface.

In the centrifugal clutch in accordance with the present invention, an oblique posture is assumed such that the output shaft side is low and the input shaft side is high, whereby the corner section of the disk-shaped wall surface of the clutch drum and the annular circumferential surface is formed to have a V-shaped cross section. As a result, if the wear dust from the lining is separated and falls down inside the drum due to contact between the lining and the drum, this wear dust is retained in the corner section of the disk-shaped wall surface and annular circumferential surface inside the clutch drum, but because the discharge ports are provided with a spacing in the corner section, the wear dust is discharged to the outside through the discharge ports by the centrifugal force generated in the drum and the vibrations of the machine body when the machine body is operated.

Furthermore, not only when the machine body is operated, but also when the rotation of the drum is stopped, as in an idling mode, because shoe weights provided with a lining on the outer peripheral surface still rotate inside the drum, the wear dust is discharged from the discharge ports by the flow force created by the rotation of the shoe drum, whereby a state is always assumed in which no wear dust is present inside the drum.

Because the wear dust present inside the drum is thus rapidly discharged to the outside and a state in which no wear dust remains in the drum is maintained at all times, the transmission loss of the clutch caused by the wear dust squeezed between the contact surfaces of the lining and the drum, as in the conventional machines, is reduced, temperature increase affecting all the structural components of the clutch is reduced, and abnormal wear of the lining is greatly improved.

### BRIEF DESCRIPTION OF THE DRAWINGS

FIG. 1 is a cross-sectional view illustrating the configuration of the centrifugal clutch in accordance with the present invention;

FIG. 2 is a cross-sections view illustrating the configuration of the centrifugal clutch of another embodiment;

FIG. 3 is a perspective view illustrating he configuration of the centrifugal clutch shown in FIG. 2;

FIG. 4 is a partially cut-out side view of a rammer carrying the conventional centrifugal clutch; and

FIG. 5 is a cross-sectional view illustrating the configuration of the conventional centrifugal clutch.

### DESCRIPTION OF THE PREFERRED EMBODIMENTS

The discharge ports for the wear dust provided in the corner section of the disk-shaped wall surface and annular circumferential surface inside a clutch drum preferably have a shape obtained by cutting out both wall surfaces leading from portions of the annular circumferential surface in the corner section to portions of the disk-shaped wall surface.

### EMBODIMENTS

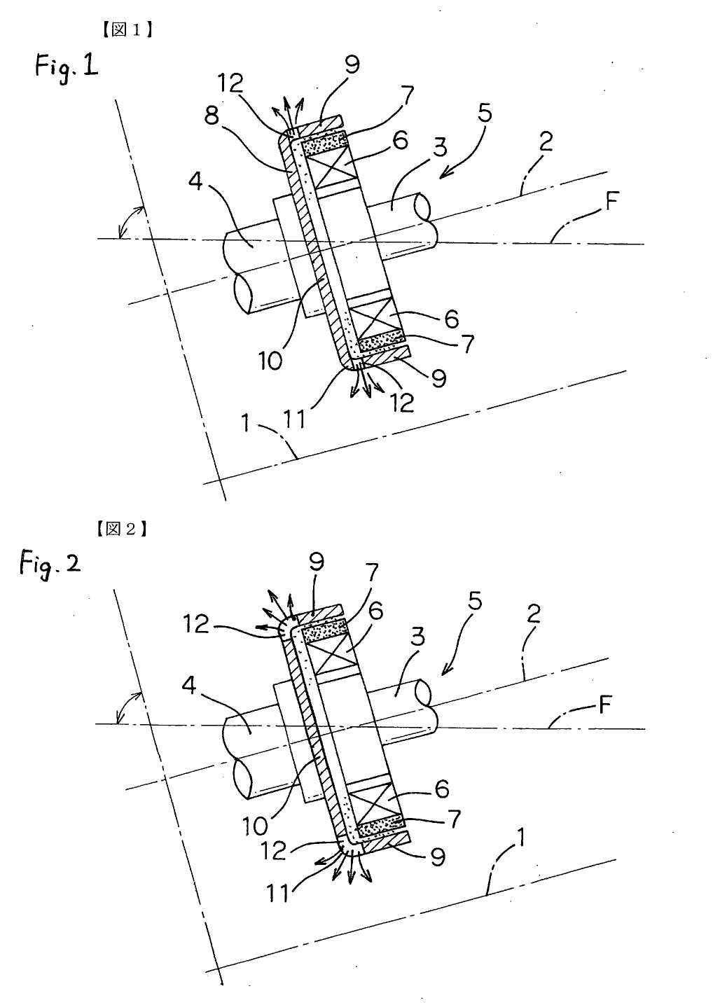

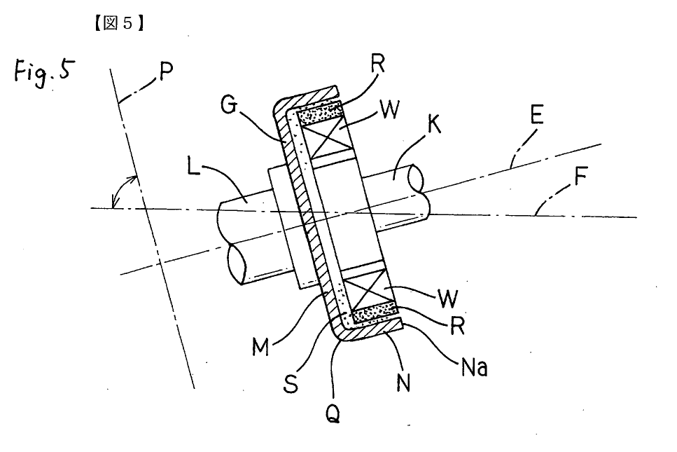

The configuration of the centrifugal clutch in accordance with the present invention will be explained below with reference to an embodiment shown in FIG. 1. This centrifugal clutch is used in an upper part of an industrial machine such as a rammer in which a central line P is inclined forward with respect to a line F parallel to the earth surface, as in the machine body 1 shown in FIG. 4. The centrifugal clutch is mounted so that a line 2 of input and output shafts of the clutch provided in the upper part of the machine body 1 is tilted in the direction such that it is high at the side of a clutch input shaft 3 (power engine side) and low at the side of the clutch output shaft 4.

As shown in FIG. 2, a centrifugal clutch 5 comprising a plurality of shoe weights 6 having respective linings 7 at the outer peripheral surface is provided at the distal end of the input shaft 3. When the speed of rotation from the power engine is low in a state where the centrifugal clutch 5 is disposed inside a clutch drum 8 provided at one end of the output shaft 4, a centrifugal force that acts to spread the shoe weights 6 is not obtained. As a result, the lining 7 does not come into contact with the inner peripheral surface of the annular circumferential surface 9 of the clutch drum 8 and, therefore, though the power engine rotates, this rotation is not transmitted to the clutch output shaft 4 and the output shaft 4 is stopped.

On the other hand, the clutch drum 8 for accommodating inside thereof the centrifugal clutch 5 comprising the shoe weights 6 is provided at one end of the output shaft 4 and when the rotation speed from the power engine is increased, the shoe weights 6 are spread by the centrifugal force inside the drum 8, the lining 7 comes into contact with the inner peripheral surface of the annular circumferential surface 9 of the clutch drum 8, and therefore the rotation of the power engine is transmitted to the clutch output shaft 4.

As shown in FIG. 1, the clutch drum 8 provided at one end of the output shaft 4 comprises a disk-shaped wall surface 10 and the annular circumferential surface 9 provided at the circumferential edge section of the wall surface 10, and a plurality of discharge ports 12 for a lining wear dust are opened with a spacing therebetween in the corner section 11 formed by the disk-shaped wall surface 10 and annular circumferential surface 9, those discharge ports being formed by cutting out portions of the annular circumferential surface 9 close to the corner section 11.

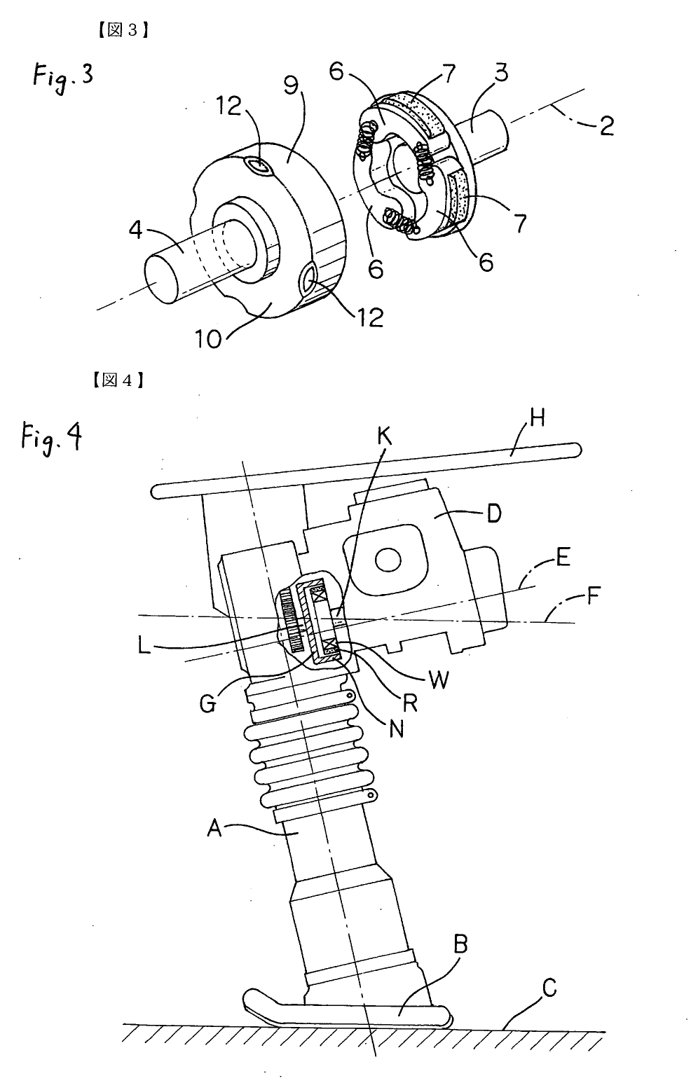

The discharge ports 12 for a lining wear dust shown in FIG. 1 were formed in the corner section 11 of the disk-shaped wall surface 10 and annular circumferential surface 9 by cutting out portions of the annular circumferential surface 9 close to the corner section 11, but as shown in FIG. 2 and FIG. 3, the discharge ports 12 for the wear dust may be also formed by cutting out the material over both wall surfaces 9, 10 from portions of the annular circumferential surface 9 to portions of the disk-shaped wall surface 10 in the corner section 11 of the disk-shaped wall surface 10 and annular circumferential surface 9.

As for the shape of discharge ports 12, a shape of holes that are opened with an expansion in the circumferential direction of the annular circumferential surface 9, as shown in FIG. 3, is more preferred than an elongated groove shape cut out to have a small width along the longitudinal direction of the input-output shaft line 2 in the corner section 11 of the disk-shaped wall surface 10 and annular circumferential surface 9.

The wear dust is separated from the lining 7 and falls down inside the drum 8 when the lining 7 comes into contact with the inner peripheral surface of the drum 8 and the output shaft 4 of the drum 8 rotates, but when the lining 7 and drum 8 rotate integrally at a high speed, this wear dust is ejected radially and discharged to the outside of the drum from the discharge ports 12 provided in the corner sections of the drum 8 by a centrifugal force generated in the drum and vibrations of the machine body.

Furthermore, even in an idling mode in which the rotation speed of the input shaft 3 of the clutch is low, the lining 7 and drum 8 are not in contact with each other, and no rotation is transmitted to the drum 8 on the side of the output shaft 4, because the shoe weights 6 on the side of the input shaft 3 rotate inside the drum 8, the wear dust is discharged through the discharge ports 12 to the outside of the drum 8 by a flow force generated by the rotation of the shoe weights 6, and the state in which the wear dust is retained inside the drum 8 can be avoided at all times.

The preferred shape of the discharge ports 12 is that of holes that are opened with an expansion in the circumferential direction of the annular circumferential surface 9 over both wall surfaces 9, 10 from portions of the annular circumferential surface 9 to portions of the disk-shaped wall surface 10 in the corner section 11 of the disk-shaped wall surface 10 and annular circumferential surface 9, as shown in FIGS. 2 and 3.

In the centrifugal clutch, a plurality of discharge ports 12 for a lining wear dust are opened in the corner section 11 of the disk-shaped wall surface 10 and annular circumferential surface 9 of the clutch drum 8, thereby enabling the reliable discharge of the wear dust that fell down from the lining 7. Therefore, the clutch transmission loss caused by the penetration of wear dust into the surface can be reduced, the increase in clutch temperature and damage of the clutch caused by wear can be reliably prevented, and the utility of the centrifugal clutches of this type for industrial machinery can be improved.

What is claimed is:

1. A centrifugal clutch for a vibration compaction machine in which a clutch drum is disposed obliquely so that an input shaft side is high and an output shaft side is low in a power transmission unit of a vibration compaction machine for compacting a road surface by an up-down movement of a compaction plate, wherein
a plurality of discharge ports for a lining wear dust are provided with a spacing therebetween in a corner section formed by a disk-shaped wall surface of the clutch drum and an annular circumferential surface provided at the circumferential edge section of the wall surface, the discharge ports being formed by cutting out portions of the annular circumferential surface close to the corner section.

2. The centrifugal clutch for a vibration compaction machine according to claim 1, wherein
a plurality of discharge ports for a lining wear dust are provided with a spacing therebetween in a corner section formed by a disk-shaped wall surface of the clutch drum and an annular circumferential surface provided at the circumferential edge section of the wall surface, the discharge ports being formed by cutting out portions of the disk-shaped wall surface and annular circumferential surface.
